(19) United States
(12) Patent Application Publication
(10) Pub. No.: US 2012/0075763 A1
(43) Pub. Date: Mar. 29, 2012

(54) SENSOR DEVICE WITH CURRENT LIMITER UNIT

(76) Inventor: Udo Sieber, Bietigheim (DE)

(21) Appl. No.: 13/247,595

(22) Filed: Sep. 28, 2011

(30) Foreign Application Priority Data
Sep. 28, 2010 (DE) 10 2010 041 499.9

(51) Int. Cl. H02H 9/02

(52) U.S. Cl. 361/93.9

(57) ABSTRACT

A sensor device for connection to a terminal of a vehicle accumulator, having a current sensor for measuring a current drawn from and/or supplied to the vehicle accumulator, in particular upon activation of a starter or generator of the vehicle as a belt starter in the start-stop mode of the vehicle, is disclosed, in which a current limiter is provided, which limits the current that is output by or drawn from the vehicle accumulator if the current measured by the current sensor, reaches an upper threshold value.

### CROSS-REFERENCE TO RELATED APPLICATION

This application is based on German Patent Application 10 2010 041 499.9 filed on Sep. 28, 2010.

### BACKGROUND OF THE INVENTION

1. Field of the Invention

The present invention relates to a sensor device, a vehicle accumulator, and a vehicle.

2. Description of the Prior Art

Sensors for measuring the state of charge of a vehicle accumulator are used at present in vehicles that have start-stop systems. In them, the current, voltage and temperature of the battery are detected. From these data, using a suitable algorithm, the state of the battery is determined in a microcontroller. The sensors and microcontroller are accommodated in a separate equipment unit, which is built directly onto the pole terminal of the vehicle accumulator.

Upon starting of the internal combustion engine or restarting in the start-stop mode, high current peaks occur with the activation of the starter or generator as a belt starter, and they lead to unacceptable voltage dips. To avoid them, the starter can be preceded by a current limiter.

From German Patent DE 198 40 819 C1, one such system is known, comprising a starter for an internal combustion engine preceded by a current limiter. In it, a current output by the vehicle accumulator is limited by a DC/DC converter to a temperature-dependent threshold value, in order to enable further starting operations even at low temperatures.

### OBJECT AND SUMMARY OF THE INVENTION

It is therefore the object of the invention to disclose a sensor device, a vehicle accumulator, and a vehicle, with which a simpler, more-reliable limitation of a current that is output to the starter of a vehicle is possible.

The fundamental concept of the invention is to integrate the current limiter with the sensor device provided in the vehicle accumulator, for detecting the current to or from the vehicle accumulator. This avoids long power cords between the vehicle accumulator and the current limiter, the inductance of which, in conventional systems, has to be counteracted by means of an expensive intermediate-circuit capacitor. According to the invention, the result is that the current to the starter can be limited virtually without loss, and the intermediate-circuit capacitor is unnecessary. The avoidance of this intermediate-circuit capacitor is advantageous not only in terms of the costs but also in terms of the system complexity, because in this way the complete system can be manufactured in a more space-saving way, and unwanted component failures can be avoided.

Also as a result, the closeness and infrastructure of the sensor device, which conventionally also includes a control device for detecting and controlling the state of the vehicle accumulator, are utilized to achieve an especially simply built-up current limitation, since the current limiter according to the invention can be triggered without problems by the sensor device.

The invention therefore discloses a sensor device for connection to a terminal of a vehicle accumulator, having a current sensor for measuring a current drawn from and/or supplied to the vehicle accumulator, in particular upon activation of a starter or generator of the vehicle as a belt starter in the start-stop mode of the vehicle. According to the invention, the sensor device has a current limiter for limiting the current that is output or drawn by the vehicle accumulator if the current measured by the current sensor reaches an upper threshold value, so that the current limiter is disposed directly at the terminal of the vehicle accumulator. Integrating the current limiter with the sensor device is especially advantageous, since typically the microcontroller and the application-specific integrated circuit (ASIC) for detecting current data detection are already present for controlling the current limiter and need not be furnished as extra components.

In a preferred embodiment, the current limiter for limiting the current that is output or drawn by the vehicle accumulator can have one or more parallel-connected semiconductor switches, in particular field-effect transistors, which block completely if the current measured by the current sensor reaches the upper threshold value. In this way, the currents for the starter, which amount to several hundred amperes, can be limited with little loss.

In a particular refinement, the semiconductor switch or semiconductor switches can be made fully conducting if the current measured by the current sensor reaches a lower threshold value. In this way, for minimizing the loss, the semiconductor switch is either made fully conducting or is fully blocked in rapid alternation, so that the current limitation is done with little loss. This clocking is possible without interfering inductance because of the short line length between the vehicle accumulator and the semiconductor switch in the sensor device, so that in this case as well, the use of an intermediate-circuit capacitor is unnecessary.

In an additional particular refinement, the lower threshold value can be variably settable.

In a further particular refinement, the upper threshold value can be variably settable.

In another particular embodiment of the invention, the current limiter, for limiting a current to a generator in operation as a starter or to a starter during starting of an internal combustion engine of the vehicle, can be provided for instance for avoiding high current peaks during starting and not unnecessarily burdening the vehicle accumulator.

The current limiter can be provided for switching off its limitation function after the starting operation, so that currents to other consumers in the current branch of the starter or generator are not unnecessarily limited.

In an additional embodiment of the invention, the current limiter can be provided for limiting a current to a generator, if the generator is operated as an electrical load for the vehicle accumulator. In the load mode of operation, the generator generates a torque which can then be controlled and set by the current limiter.

The invention also discloses a vehicle accumulator with a terminal for outputting or drawing a current, in which a sensor device of the invention is connected to the terminal.

The invention also discloses a vehicle having a vehicle accumulator according to the invention.

In a preferred embodiment, the vehicle can have a control unit for controlling a vehicle motor, and the control unit is provided for setting the upper and/or lower threshold value. As a result, the starting current of the starter can be suitably specified in advance, in order to provide for gentle starting, without startup shock.

In a further particular embodiment of the invention, the vehicle can have a generator, which is operated with active commutation electronics and is provided for outputting current to the accumulator or for drawing current from the accumulator via the sensor device and can have an internal combustion engine; the control unit is provided for setting the upper threshold value in such a way that the current drawn or output by the generator during operation, in particular during shutting down and/or starting up, of the engine does not exceed a maximum threshold value for the generator current. In this way, defined current courses can be impressed on the generator and can be converted by the generator into suitable torque courses. It is thus possible for instance to effectively damp shaking of the engine during its shutdown by means of suitable compensatory torques. It is also possible as a result to minimize fluctuations in synchronization of the engine during the driving mode of the vehicle.

In a further particular embodiment of the invention, the control unit can be provided for determining a total consumer current from the currents of the consumers that in addition to the generator are connected to the generator to the vehicle accumulator and for setting the upper threshold value based on a sum of a maximum threshold value for the generator current and the total consumer current. As a result, directly before the desired current impression of the generator or starter, the consumer current can be detected and supplied as an offset to the current impression phase.

In an additional embodiment of the invention, based on the vehicle accumulator in the sensor device, a free-wheel circuit can be provided downstream of the current limiter, so that the inductive resistors downstream of the current limiter can be operated with little loss.

The invention will be better understood and further objects and advantages thereof will become more apparent from the ensuing detailed description of preferred embodiments taken in conjunction with the drawings.

### BRIEF DESCRIPTION OF THE DRAWINGS

The invention will be better understood and further objects and advantages thereof will become more apparent from the ensuing detailed description of a preferred embodiment taken in conjunction with the drawings, in which:

FIG. 1 is a basic circuit diagram of one exemplary embodiment of the invention in an on-board electrical system of a vehicle;

FIG. 2 shows one exemplary embodiment of an electrical circuit for connection of the generator to the vehicle accumulator via the current limiter stage according to the invention of FIG. 1;

FIG. 3 is a current-time graph for explaining the mode of operation of the semiconductor switch of FIG. 2; and

FIG. 4 is a current-time graph which shows one exemplary embodiment for impressing current according to the invention.

### DESCRIPTION OF THE PREFERRED EMBODIMENTS

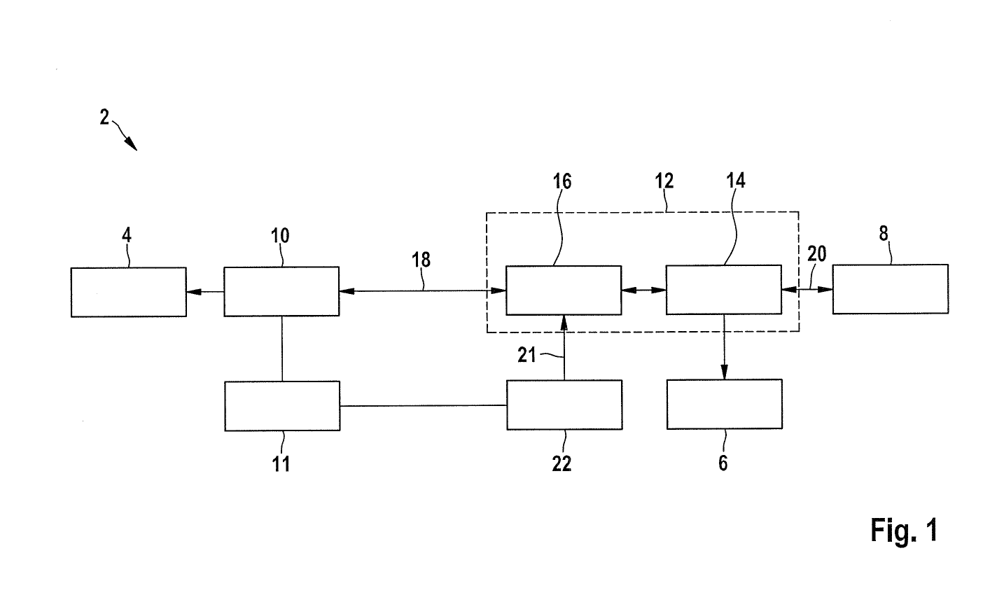

In FIG. 1, one exemplary embodiment of the invention in an on-board electrical system 2 of a vehicle is shown on the basis of a basic circuit diagram.

In the on-board electrical system 2, electrical consumers 4, 6 are supplied with electric current via a vehicle accumulator 8, conventionally called a battery, and a generator 10. The generator 10 itself can also be a consumer in the on-board electrical system 2 and, with the current that is output by the vehicle accumulator 8, can start an internal combustion engine 11, for instance in the start-stop mode of operation of the vehicle. It is then used in the vehicle as a belt starter. For starting the engine 11, any other starter may be used as an alternative to the generator 10.

A sensor device 12 according to the invention is connected directly to one of the terminals of the vehicle accumulator 8. This sensor device preferably comprises a conventional sensor device for state-of-charge management of the vehicle accumulator 8. Such conventional sensor devices can have state-of-charge management components 14, which are suitable for measuring the temperature, voltage and output currents of the vehicle accumulator 8 and initiating suitable provisions, for instance for avoiding a deep discharge of the vehicle accumulator 8. This can happen for instance because a microcontroller among the state-of-charge management components 14 switches off one of the consumers 4, 6, if there is the threat of an impending deep discharge of the vehicle accumulator 8.

Besides the state of charge components 14, a current limiter 16 is disposed in the sensor device 12 of the invention, in order to limit a current 20 that is drawn from or output by the vehicle accumulator 8. In FIG. 1, the current 20 to be limited includes the current that is output by the vehicle accumulator 8, which supplies the consumer 4 and the generator 10 in the mode of operation as a starter. The limited current 18, which thus flows through the branch of the on-board electrical system 2 that includes the generator 10, is therefore hereinafter called the generator current 18.

The current 20 to be limited can in principle be any current which is output at a particular consumer 4, 6 or a particular consumer group—and thus can also be the entire current output by or drawn from the vehicle accumulator 8.

In the mode of operation of the generator 10 as a starter, once the engine 11 turns over, the limitation of the generator current 19 has the advantage that the vehicle accumulator 8 is protected against excessive loads from excessively high current peaks in the generator current 19.

In order that the limitation of the generator current will not unnecessarily limit the operation of the remaining consumers 4 in the generator branch, the current limiter 16 in the present embodiment is switched on during the starting process of the engine 11 by a freely programmable digital engine controller 22 for internal combustion engines, for instance known as a Motronic, via a direct signal connection 21, and the rest of the time it is switched off. Triggering the current limiter 16 by the motor controller can alternatively be done via other signaling paths instead, such as via a CAN bus. If the current limiter 16 is ON, then as described above it limits the generator current 18. In the OFF state of the current limiter 16, the current limiter is fully conducting and allows arbitrarily high generator currents 18.

Since the current limiter 16 is integrated with the sensor device 12 that is connected to the terminal of the vehicle accumulator 8, the vehicle accumulator line length between the vehicle accumulator 8 and the sensor device 12 is considerably shorter than the generator line length between the vehicle accumulator 8 and the generator 10. Problematic line inductances that have high impedance in operation of the current limiter 16 therefore do not occur over the accumulator line length and make an intermediate-circuit capacitor for smoothing the generator current unnecessary here.

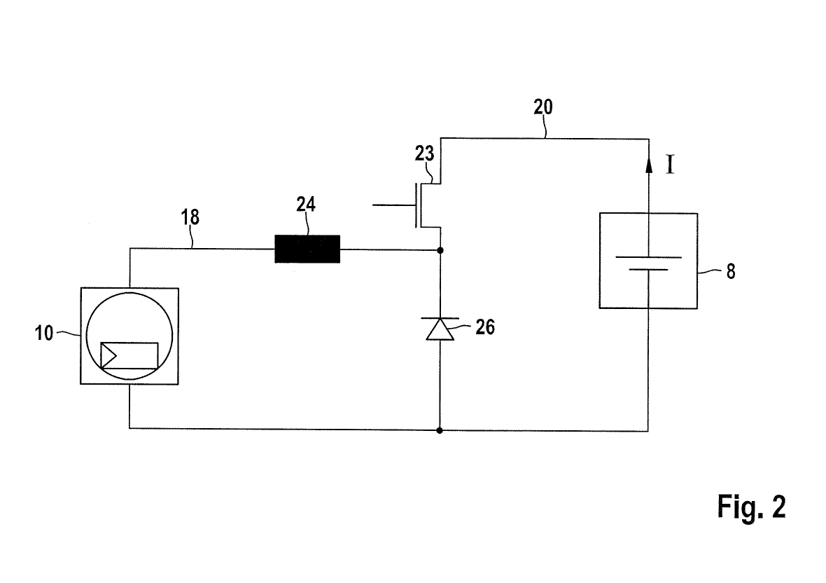

In FIG. 2, an exemplary embodiment of the current limiter 16 between the generator branch comprising the generator 10 and the consumer 4, between the vehicle accumulator 8 and the engine controller 22 of FIG. 1, is shown. The remaining elements of FIG. 1 have been left out in FIG. 2 for the sake of simpler illustration.

In the present example, the generator 10 is a direct current generator, which in the mode of operation as a starter draws current as an electrical load from the vehicle accumulator 8. Alternatively, a three-phase generator, which is supplied with current from the vehicle accumulator 8 via a plurality of lanes, is used; in that case, suitable components for generating and reshaping a three-phase alternating current from the direct current of the vehicle accumulator 8 must be provided.

The current limiter 16 has a semiconductor switch 23, which can be embodied for instance as one or more parallel-connected MOSFETs. The switch 23 can be made fully conducting or fully blocked by a Schmitt trigger 25 in rapid alternation, so that losses from the current limitation are maximally avoided. The Schmitt trigger 25 is an electronic voltage comparator circuit, in which the make and break thresholds do not coincide.

The Schmitt trigger 25 can be triggered via a shunt resistor 24 that is connected in series with the generator branch. For triggering, an operational amplifier, at its inputs, picks up the voltage drop at the shunt resistor 24 and outputs a voltage to one input of the Schmitt trigger 25. The other input of the Schmitt trigger 25 is connected to ground. The output of the Schmitt trigger 25 is connected to the control input of the semiconductor switch 23, in order to make the semiconductor switch fully conducting or to block it completely.

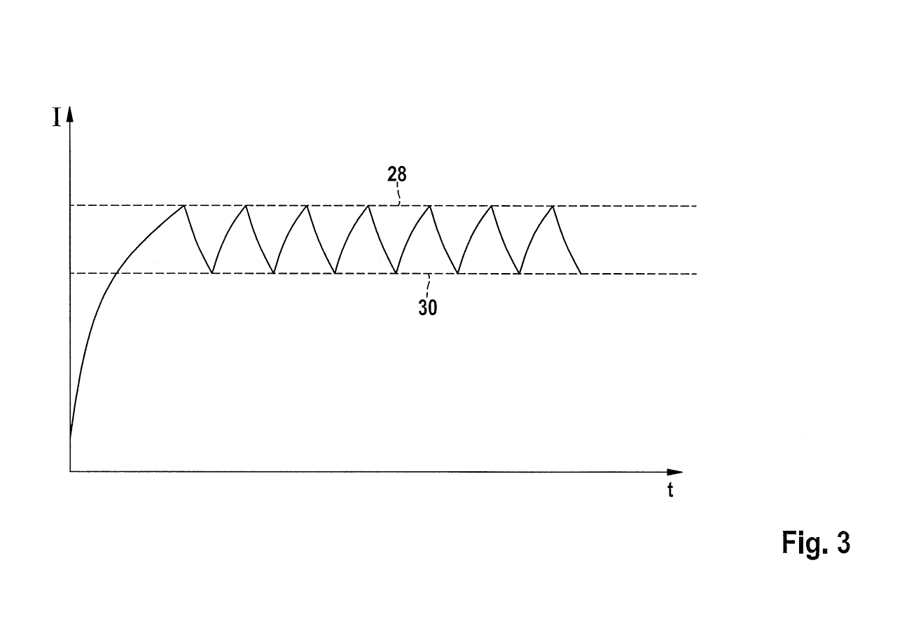

The make and break thresholds of the Schmitt trigger 25 are settable by the engine controller 22 via the signal connection 21. In the OFF state of the current limiter 16, both thresholds are placed at suitable values so that the current limiter 16 is continuously conducting. In the ON state, both thresholds of the Schmitt trigger 25 are set at suitable values, so that the generator current 18 oscillates back and forth between the two thresholds. This will be described later in further detail in conjunction with FIG. 3.

The Schmitt trigger 25 and the remaining components for triggering the semiconductor switch 23 can be accommodated in the module of the state-of-charge components 14 or can use the corresponding functionality of that module, as long as it is suitable for triggering the semiconductor switch 23 for limiting the generator current 18.

In the arrangement of FIG. 2, problematic line inductances do not occur over the accumulator line length, but only over the generator line length; in FIG. 3, the total inductance of all the inductive resistors of the current circuit shown, which is formed in particular by the shunt resistor 24 of the generator 10. To operate this inductive resistor 24 with little loss, in the present exemplary embodiment a free-wheel circuit is provided, in the form of a diode 26. However, this is only one example for a free-wheel circuit, which can also be achieved by means of other suitable electrical components, such as a further MOSFET.

The mode of operation of the Schmitt trigger 25 and the control of the semiconductor switch 23 in the current limiter 16 will now be described in conjunction with FIG. 3.

In the current-time graph in FIG. 3, the generator current I is plotted over the time t within the break threshold 28 and the make threshold 30 of the Schmitt trigger 25.

At the beginning, the Schmitt trigger 25 makes the semiconductor switch 23 conducting. As soon as the generator current reaches the break threshold 28, the semiconductor switch 23 is blocked. The blocked state is maintained until the generator current drops to the make threshold 30, and the semiconductor switch 23 is made conducting, as at the beginning.

In this way, the low-loss current limitation already mentioned is achieved.

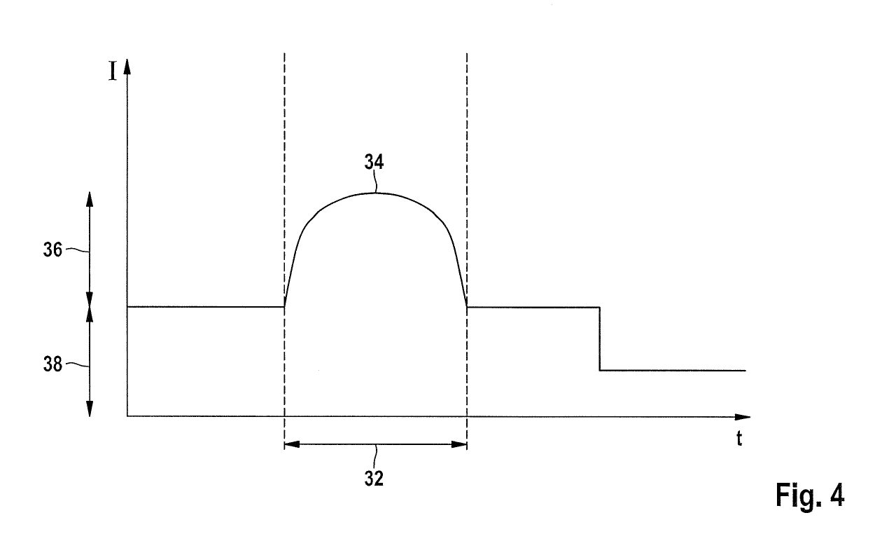

The mode of operation over time of the current limiter 16 will be described in further detail in conjunction with FIG. 4.

Within a starting phase 40 of the internal combustion engine 11, the current limiter 16, with the thresholds 28, 30 of the Schmitt trigger 25, limits the generator current I via the semiconductor switch 23. The generator current I is indicated in FIG. 4 by its effective value.

If the engine 11 has started, and thus the generator 10 is no longer needed as a starter and thus as an electrical load, the semiconductor switch 23 is switched to conducting in a normal mode of operation phase 42, so that the consumers 4 connected to the generator 10 can draw an arbitrary amount of generator current 18 from the vehicle accumulator 8.

In a particularly preferred embodiment, the current limiter 16 is always switched on whenever the generator 10 is being operated as a load. This is especially advantageous if the generator 10 has active commutation electronics and can exert torques on the engine 11. These torques can be used as counter-torques, for damping shaking of the engine 11 upon vehicle braking.

As the engine 11 comes to a stop, rpm fluctuations, which are known as shutoff shaking, can occur as a result of the stoppage of combustion processes in the cylinders of the engine 11. To avoid this shutoff shaking, the active commutation electronics can draw a current 36 from the vehicle accumulator 8 and with this current can operate the generator 10 as a motor, in order to generate the counter-torque that damps the shutoff shaking of the engine 11.

In this case, the current limiter 16 can be used to limit the magnitude of the counter-torque by limiting the available generator current 10 during the braking phase 42 of the engine 11. In this way, the maximum torque of the generator 10 is precisely high enough that it effectively damps the shaking of the engine 11, yet the number of engine revolutions from the shutoff until the standstill of the engine is still sufficient to ensure a minimum number of scavenging operations of the combustion chambers.

Since the shutoff shaking is not constant over the duration of the braking phase 32 of the engine 11, the engine controller, for further improving the damping of engine shaking, can variably set the make and break thresholds 28, 30 of the Schmitt trigger 25 of the current limiter 16 during the braking phase 32. In this way, a certain course of the current 36 is impressed on the generator 10, so that the intensity of the counter-torque can be adapted to the magnitude of the shutoff shaking. Setting the thresholds 28, 30 can be done via the engine controller 22, which as shown in FIG. 2 can vary the thresholds 28, 30 by way of the signal line 21.

After the braking phase 32 of the engine 11, the current limiter 16 can be shut off again, and in a further normal mode of operation phase 42, the semiconductor switch 23 can be switched to the conducting mode.

In the same way, upon startup of the engine 11, a certain course of the current 36 can be impressed on the generator 10 in order to achieve a gentle startup without startup shock, or in operation of the engine a certain current course can be impressed on the generator in order to suppress unwanted vibration that occurs then, for instance brought about a cylinder shutoff.

In a further improved embodiment, in impressing the current 36 on the generator 10, the current 38 drawn beforehand by the consumer 4 in the generator branch can also be taken into account, which leads to more-precise generation of the countertorque.

If the generator current is limited and if the consumer 4 present in the generator branch takes up a current 38, then the torque that can be put out by the generator 10 is made less. To avoid that, before the current 36 is impressed, the actual consumer current 38 can be determined and can be supplied as an offset, as shown in FIG. 4. The measurement of the consumer current 38 can be done for instance by means of the engine

1-20. (canceled)

21. A sensor device for connection to a terminal of a vehicle accumulator, comprising:
a current sensor for measuring a current drawn from and/or supplied to the vehicle accumulator upon activation of a starter or generator of the vehicle as a belt starter in the start-stop mode of the vehicle; and
a current limiter for limiting the current that is output by or drawn from the vehicle accumulator, if the current measured by the current sensor reaches an upper, variably settable threshold value.

22. The sensor device as defined by claim 21, wherein the current limiter, for limiting the current that is output by or drawn from the vehicle accumulator, has one or more parallel-connected semiconductor switches, embodied as field-effect transistors, which are blocked completely if the current measured by the current sensor reaches the upper threshold value.

23. The sensor device as defined by claim 22, wherein the semiconductor switch or semiconductor switches are made fully conducting if the current measured by the current sensor reaches a lower threshold value.

24. The sensor device as defined by claim 23, wherein the lower threshold value is variably settable.

25. The sensor device as defined by claim 21, wherein the current limiter is provided for limiting a current to a generator in operation as a starter or to a starter during starting of an internal combustion engine of the vehicle, and wherein the current limiter is provided for switching off its limiting function after the starting process.

26. The sensor device as defined by claim 22, wherein the current limiter is provided for limiting a current to a generator in operation as a starter or to a starter during starting of an internal combustion engine of the vehicle, and wherein the current limiter is provided for switching off its limiting function after the starting process.

27. The sensor device as defined by claim 23, wherein the current limiter is provided for limiting a current to a generator in operation as a starter or to a starter during starting of an internal combustion engine of the vehicle, and wherein the current limiter is provided for switching off its limiting function after the starting process.

28. The sensor device as defined by claim 24, wherein the current limiter is provided for limiting a current to a generator in operation as a starter or to a starter during starting of an internal combustion engine of the vehicle, and wherein the current limiter is provided for switching off its limiting function after the starting process.

29. The sensor device as defined claim 21, wherein the current limiter is provided for limiting a current to a generator if the generator is operated as an electrical load for the vehicle accumulator.

30. The sensor device as defined claim 28, wherein the current limiter is provided for limiting a current to a generator if the generator is operated as an electrical load for the vehicle accumulator.

31. A vehicle accumulator with a terminal for outputting or drawing a current, having a sensor device as defined by claim 21 that is connected to the terminal.

32. A vehicle accumulator with a terminal for outputting or drawing a current, having a sensor device as defined by claim 30 that is connected to the terminal.

33. A vehicle having a vehicle accumulator as defined by claim 31.

34. A vehicle having a vehicle accumulator as defined by claim 32.

35. The vehicle as defined by claim 33, having a control unit for controlling an internal combustion engine of the vehicle, wherein the control unit is provided for setting the upper and/or a lower threshold value.

36. The vehicle as defined by claim 34, having a control unit for controlling an internal combustion engine of the vehicle, wherein the control unit is provided for setting the upper and/or a lower threshold value.

37. The vehicle as defined by claim 35, having a generator operated with active commutation electronics, for outputting current to the vehicle accumulator or for drawing current from the vehicle accumulator via the sensor device, wherein the control unit is provided for setting the upper threshold value in such a way that the current that is drawn from or output by the generator, during an operating mode of shutting down and/or starting up of the engine, does not exceed a maximum threshold value for the generator current.

38. The vehicle as defined by claim 36, having a generator operated with active commutation electronics, for outputting current to the vehicle accumulator or for drawing current from the vehicle accumulator via the sensor device, wherein the control unit is provided for setting the upper threshold value in such a way that the current that is drawn from or output by the generator, during an operating mode of shutting down and/or starting up of the engine, does not exceed a maximum threshold value for the generator current.

39. The vehicle as defined by claim 37, wherein the control unit is provided for determining a total consumer current from the currents of the consumers, in addition to the generator, are connected to the vehicle accumulator, and for setting the upper threshold value based on a sum of a maximum threshold value for the generator current and the total consumer current.

40. The vehicle as defined by claim 38, wherein the control unit is provided for determining a total consumer current from the currents of the consumers, in addition to the generator, are connected to the vehicle accumulator, and for setting the upper threshold value based on a sum of a maximum threshold value for the generator current and the total consumer current.
